(19) United States
(12) Patent Application Publication
(10) Pub. No.: US 2024/0161445 A1
(43) Pub. Date: May 16, 2024

(54) OBJECT DETECTION APPARATUS, OBJECT DETECTION SYSTEM, OBJECT DETECTION METHOD, AND RECORDING MEDIUM

(71) Applicant: NEC Corporation, Minato-ku, Tokyo (JP)

(72) Inventor: Masaya FUJIWAKA, Tokyo (JP)

(73) Assignee: NEC Corporation, Minato-ku, Tokyo (JP)

(21) Appl. No.: 18/284,610

(22) PCT Filed: Apr. 7, 2021
(86) PCT No.: PCT/JP2021/014768

§ 371 Date: Sep. 28, 2023

(51) Int. Cl. G06V 10/40; G06V 10/776; G06V 10/82; H04N 19/136

(52) U.S. Cl. CPC G06V 10/40; G06V 10/776; G06V 10/82; H04N 19/136; G06V 2201/07

(57) ABSTRACT

An object detection apparatus includes: a generation unit that performs compression encoding on each of a first image obtained from an image generation apparatus and a second image indicating a detection target object so as to extract a feature quantity that allows object detection and so as to be decoded later, thereby generate respective one of first encoding information that is the compressed, encoded first image and that is usable as a first feature quantity that is the feature quantity of the first image, and second encoding information that is the compressed, encoded second image and that is usable as a second feature quantity that is the feature quantity of the second image; and a detection unit that detects the detection target object in the first image, by using the first and second feature quantities.

### TECHNICAL FIELD

This disclosure relates, for example, to technical fields of an object detection apparatus, an object detection system, an object detection method, and a recording medium that are capable of detecting a detection target object in an image.

### BACKGROUND ART

Patent Literature 1 discloses an example of an object detection apparatus that detects a detection target object in an image, by using a neural network.

In addition, as prior art documents related to this disclosure, Patent Literature 2 to Patent Literature 4 are cited.

### CITATION LIST

### Patent Literature

Patent Literature 1: International Publication No. WO2020/031422 pamphlet
Patent Literature 2: JP2020-051982A
Patent Literature 3: Japanese Patent No. 6605742
Patent Literature 4: International Publication No. WO2017/187516 pamphlet

### SUMMARY

### Technical Problem

The object detection apparatus sometimes transmits an image to an information processing apparatus disposed outside the object detection apparatus, through a communication line, in parallel with an object detection process that detects the detection target object in the image. As an example, when the object detection apparatus is mounted on a portable terminal that has a relatively low throughput or processing capability, the object detection apparatus may transmit an image to an information processing apparatus that is configured to perform an information process that requires a relatively high throughput or processing capability, on the image.

In this situation, in order to satisfy bandwidth constraints on the communication line, the object detection apparatus may compress an image and transmit the compressed image to the information processing apparatus. In this case, the object detection apparatus needs to perform a compression encoding operation for compressing the image, independently of an object detection operation. The object detection apparatus, however, does not necessarily have a throughput or processing capability high enough to independently perform the object detection operation and the compression encoding operation. Therefore, it is desirable to reduce a processing load for performing the object detection operation and the compression encoding operation.

It is an example object of this disclosure to provide an object detection apparatus, an object detection system, an object detection method, and a recording medium that are capable of solving the above-described technical problems. It is an example object of this disclosure to provide an object detection apparatus, an object detection system, an object detection method, and a recording medium that are capable of reducing a processing load for compressing an image and for detecting a detection target object in the image.

### Solution to Problem

An object detection apparatus according to this disclosure includes: a generation unit that performs compression encoding on each of a first image obtained from an image generation apparatus and a second image indicating a detection target object so as to extract a feature quantity that allows object detection and so as to be decoded later, thereby generate respective one of first enencoding information that is the compressed, encoded first image and that is usable as a first feature quantity that is the feature quantity of the first image, and second enencoding information that is the compressed, encoded second image and that is usable as a second feature quantity that is the feature quantity of the second image; and a detection unit that detects the detection target object in the first image, by using the first and second feature quantities.

An object detection system according to this disclosure is an object detection system comprising an object detection apparatus and an information processing apparatus, the object detection apparatus including: a generation unit that performs compression encoding on each of a first image obtained from an image generation apparatus and a second image indicating a detection target object so as to extract a feature quantity that allows object detection and so as to be decoded later, thereby generate respective one of first enencoding information that is the compressed, encoded first image and that is usable as a first feature quantity that is the feature quantity of the first image, and second enencoding information that is the compressed, encoded second image and that is usable as a second feature quantity that is the feature quantity of the second image; a detection unit that detects the detection target object in the first image, by using the first and second feature quantities; and a transmission unit that transmits the first enencoding information to the information processing apparatus, through a communication line, the information processing apparatus performing a predetermined operation using the first enencoding information.

An object detection method according to this disclosure includes: performing compression encoding on each of a first image obtained from an image generation apparatus and a second image indicating a detection target object so as to extract a feature quantity that allows object detection and so as to be decoded later, thereby generate respective one of first enencoding information that is the compressed, encoded first image and that is usable as a first feature quantity that is the feature quantity of the first image, and second enencoding information that is the compressed, encoded second image and that is usable as a second feature quantity that is the feature quantity of the second image; and detecting the detection target object in the first image, by using the first and second feature quantities.

A recording medium according to this disclosure is a recording medium on which a computer program that allows a computer to execute an object detection method is recorded, the object detection method including: performing compression encoding on each of a first image obtained from an image generation apparatus and a second image indicating a detection target object so as to extract a feature quantity that allows object detection and so as to be decoded later, thereby generate respective one of first enencoding information that is the compressed, encoded first image and that is usable as a first feature quantity that is the feature quantity of the first image, and second enencoding information that is the compressed, encoded second image and that is usable as a second feature quantity that is the feature quantity of the second image; and detecting the detection target object in the first image, by using the first and second feature quantities.

### Effect of Invention

According to the object detection apparatus, the object detection system, the object detection method, and the recording medium described above, it is possible to reduce a processing load for compressing the first image and for detecting the detection target object in the first image.

### BRIEF DESCRIPTION OF DRAWINGS

FIG. 1 is a block diagram illustrating an overall configuration of an object detection system according to an example embodiment.

FIG. 2 is a block diagram illustrating a configuration of an object detection apparatus according to the example embodiment.

FIG. 3 schematically illustrates a structure of a neural network used by the object detection apparatus according to the example embodiment.

FIG. 4 is a block diagram illustrating a configuration of an information processing apparatus according to the example embodiment.

FIG. 5 is a flowchart illustrating a flow of operation of the object detection system according to the example embodiment.

FIG. 6 conceptually illustrates machine learning for generating a computational model used by an object detection apparatus.

FIG. 7 schematically illustrates a structure of a neural network used by an object detection apparatus according to a comparative example.

FIG. 8 is a block diagram illustrating a configuration of an object detection apparatus according to a modified example.

### DESCRIPTION OF EXAMPLE EMBODIMENT

Hereinafter, with reference to the drawings, an object detection apparatus, an object detection system, an object detection method, and a recording medium according to an example embodiment will be described. The following describes the object detection apparatus, the object detection system, the object detection method, and the recording medium according to the example embodiment, by using an object detection system SYS to which the object detection apparatus, the object detection system, the object detection method, and the recording medium according to the example embodiment are applied. The present invention, however, is not limited to the example embodiment described below.

### <1> Configuration of Object Detection System SYS

First, a configuration of the object detection system SYS according to the example embodiment will be described.

### <1-1> Overall Configuration of Object Detection System SYS

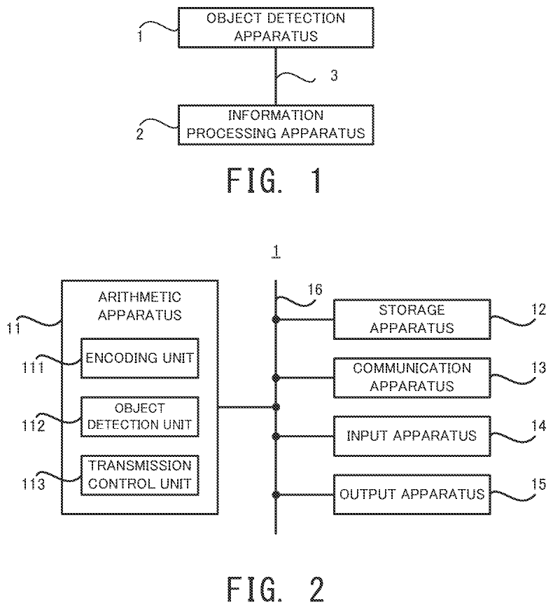

First, an overall configuration of the object detection system SYS according to the example embodiment will be described with reference to FIG. 1. FIG. 1 is a block diagram illustrating the overall configuration of the object detection system SYS according to the example embodiment.

As illustrated in FIG. 1, the object detection system SYS includes an object detection apparatus 1 and an information processing apparatus 2. The object detection apparatus 1 and the information processing apparatus 2 are configured to communicate with each other through a communication line 3. The communication line 3 may include a wired communication line. The communication line 3 may include a wireless communication line.

The object detection apparatus 1 is configured to detect a detection target object in an original image IMG_original. That is, the object detection apparatus 1 is configured to perform object detection. The original image IMG_origina is an image in which the detection target object is to be detected. The object detection apparatus 1 may obtain the original image IMG_original from an image generation apparatus, such as a camera. In the example embodiment, the object detection apparatus 1 uses a detection target image IMG_target indicating the detection target object, in order to detect the detection target object in the original image IMG_original. That is, the object detection apparatus 1 uses the original image IMG_original and the detection target image IMG_target, to detect the detection target object indicated by the detection target image IMG_target, in the original image IMG_original. Specifically, the object detection apparatus 1 generates a feature quantity CM_original of the original image IMG_original, as a feature quantity that allows the object detection, on the basis of the original image IMG_original. Furthermore, the object detection apparatus 1 generates a feature quantity CM_target of the detection target image IMG_target, as the feature quantity that allows the object detection, on the basis of the detection target image IMG_target. Then, the object detection apparatus 1 detects the detection target object in the original image IMG_original, on the basis of the feature quantity CM_original and the feature quantity CM_target.

The object detection apparatus 1 further performs compression encoding on the original image IMG_original so as to be decoded later. In other words, the object detection apparatus 1 performs a desired compression encoding process on the original image IMG_original, thereby to perform a process of converting into a data structure (information format, information form) that allows a decoding process corresponding to the desired compression encoding process to be performed later. Hereinafter, in the present application, performing a desired compression encoding process on an input image that has a certain data structure, thereby converting into a data structure (information format, information form) that allows a decoding process corresponding to the desired compression encoding process to be performed later, will be expressed as “performing compression encoding on the input image so as to be decoded later” or “performing compression encoding on the input image so as to be decoded later”. In addition, the term “input image” here is used to replace an image properly named in accordance with a description.

As a result of the compression encoding, the object detection apparatus 1 generates enencoding information EI_original that is the compressed, encoded original image IMG_original. The object detection apparatus 1 transmits the generated enencoding information EI_original to the information processing apparatus 2 through the communication line 3. As a consequence, as compared when the cases where the original image IMG_original is transmitted to the information processing apparatus 2 through the communication line 3, it is more likely to satisfy bandwidth constraints on the communication line 3.

Especially in this example embodiment, the object detection apparatus 1 uses the enencoding information EI_original, as the feature quantity CM_original of the original image IMG_original (i.e., the feature quantity CM_original for detecting the detection target object). That is, the object detection apparatus 1 performs the compression encoding on the original image IMG_original, thereby to generate the encoding information EI_original that is usable as the feature quantity CM_original. More specifically, the object detection apparatus 1 by performs the compression encoding on the original image IMG_original so as to extract the feature quantity that allows the object detection and so as to be decoded later, thereby to generate the encoding information EI_original that is usable as the feature quantity CM_original (in other words, thereby to generate the feature quantity CM_original that is usable as the encoding information EI_original).

As described above, in order to detect the detection target object, the object detection apparatus 1 uses the detection target image IMG_target, in addition to the original image IMG_original. Therefore, the object detection apparatus 1 generates encoding information EI_target that is the compressed, encoded detection target image IMG_target, as the feature quantity CM_target of the detection target image IMG_target (i.e., the feature quantity CM_target for detecting the detection target object), in addition to the feature quantity CM_original. That is, the object detection apparatus 1 performs the compression encoding on the detection target image IMG_target, as in the compression encoding of the original image IMG_original, thereby to generate the encoding information EI_target that is usable as the feature quantity CM_target. More specifically, the object detection apparatus 1 performs the compression encoding on the detection target image IMG_target so as to extract the feature quantity that allows the object detection and so as to be decoded later, thereby to generate the encoding information EI_target that is usable as the feature quantity CM_target (in other words, thereby to generate the feature quantity CM_target that is usable as the encoding information EI_target). The object detection apparatus 1 may or may not transmit the generated encoding information EI_target to the information processing apparatus 2 through the communication line 3.

The information processing apparatus 2 receives (i.e., obtains) the encoding information EI_original from the object detection apparatus 1 through the communication line 3. The information processing apparatus 2 performs a predetermined operation using the received encoding information EI_original. The example embodiment describes, as an example of the predetermined operation, an example in which the information processing apparatus 2 performs a decoding operation of decoding the encoding information EI_original, thereby to generate a decoded image IMG_dec.

A specific example of such an object detection system SYS includes, for example, an Augmented Reality (AR) system. The Augmented Reality is a technique/technology of detecting a real object that exists in a real space and placing a virtual object at a location where the real object exists in an image that indicates the real space. In the Augmented Reality system, the object detection apparatus 1 may be applied to a portable terminal such as a smart phone. In this case, the object detection apparatus 1 may detect the detection image object (i.e., the real object) in the original image IMG_original generated by a camera of the portable terminal imaging the real space, and may place a virtual object at a location where the detected detection target object exists, in the original image IMG_original. In this case, the information processing apparatus 2 may perform the decoding operation, thereby to generate the decoded image IMG_dec, and may also perform an image analysis operation of analyzing the decoded image IMG_dec. A result of the image analysis operation may be transmitted to the portable terminal. In this instance, the portable terminal may place the virtual object, on the basis of a result of the image analysis operation by the information processing apparatus 2, in addition to a detection result of the detection target object by the object detection apparatus 1. An example of the image analysis operation by the information processing apparatus 2 is an operation of estimating a direction of the portable terminal on the basis of the decoded image IMG_dec. In this instance, the portable terminal may place the virtual object on the basis of the direction of the portable terminal estimated by the image analysis operation performed by the information processing apparatus 2.

### <1-2> Configuration of Object Detection Apparatus 1

Next, a configuration of the object detection apparatus 1 will be described with reference to FIG. 2. FIG. 2 is a block diagram illustrating the configuration of the object detection apparatus 1.

As illustrated in FIG. 2, the object detection apparatus 1 includes an arithmetic apparatus 11, a storage apparatus 12, and a communication apparatus 13. Furthermore, the object detection apparatus 1 may include an input apparatus 14 and an output apparatus 15. The object detection apparatus 1, however, may not include at least one of the input apparatus 14 and the output apparatus 15. The arithmetic apparatus 11, the storage apparatus 12, the communication apparatus 13, the input apparatus 14, and the output apparatus 15 may be connected through a data bus 16.

The arithmetic apparatus 11 includes, for example, at least one of a CPU (Central Processing Unit), a GPU (Graphics Processing Unit), and a FPGA (Field Programmable Gate Array). The arithmetic apparatus 11 reads a computer program. For example, the arithmetic apparatus 11 may read a computer program stored in the storage apparatus 12. For example, the arithmetic apparatus 11 may read a computer program stored by a computer-readable and non-transitory recording medium, by using a not-illustrated recording medium reading apparatus provided in the object detection apparatus 1. The arithmetic apparatus 11 may obtain (i.e., download or read) a computer program from a not-illustrated apparatus disposed outside the object detection apparatus 1, through the communication apparatus 13 (or another communication apparatus). The arithmetic apparatus 11 executes the read computer program. Consequently, a logical functional block for performing an operation (in other words, a process) to be performed by the object detection apparatus 1 is realized or implemented in the arithmetic apparatus 11. That is, the arithmetic apparatus 11 is allowed to function as a controller for realizing or implementing the logical functional block for performing the operation to be performed by the object detection apparatus 1.

FIG. 2 illustrates an example of the logical functional block realized or implemented in the arithmetic apparatus 11. As illustrated in FIG. 2, an encoding unit 111 that is a specific example of the “generation unit”, an object detection unit 112 that is a specific example of the “detection unit”, and a transmission control unit 113 that is a specific example of the “transmission unit” are realized or implemented in the arithmetic apparatus 11.

The encoding unit 111 performs the compression encoding on the original image IMG_original so as to be decoded later, thereby to generate the encoding information EI_original that is usable as the feature quantity CM_original of the original IMG_original. In addition, the encoding unit 111 performs the compression encoding on the detection target image IMG_target so as to be decoded later, thereby to generate the encoding information EI_target that is usable as the feature quantity CM_target of the detection target image IMG_target.

The object detection unit 112 detects the detection target object in the original image IMG_original on the basis of the feature quantity CM_original and the feature quantity CM_target generated by the encoding unit 111.

In this example embodiment, the encoding unit 111 generates the encoding information EI_original and the EI_target (i.e., the feature quantities CM_original and the CM_target) by using a computational model generated by machine learning. In addition, the object detection unit 112 detects the detection target object in the original image IMG_original, by using the computational model generated by the machine learning.

The computational model may include a compression encoding model and an object detection model. The compression encoding model may be mainly a model for generating the encoding information EI_original and EI_target (i.e., the feature quantities CM_original and CM_target). The object detection model may be mainly a model for detecting the detection target object in the original image IMG_original, on the basis of the feature quantities CM_original and CM_target (i.e., the encoding information EI_original and EI_target).

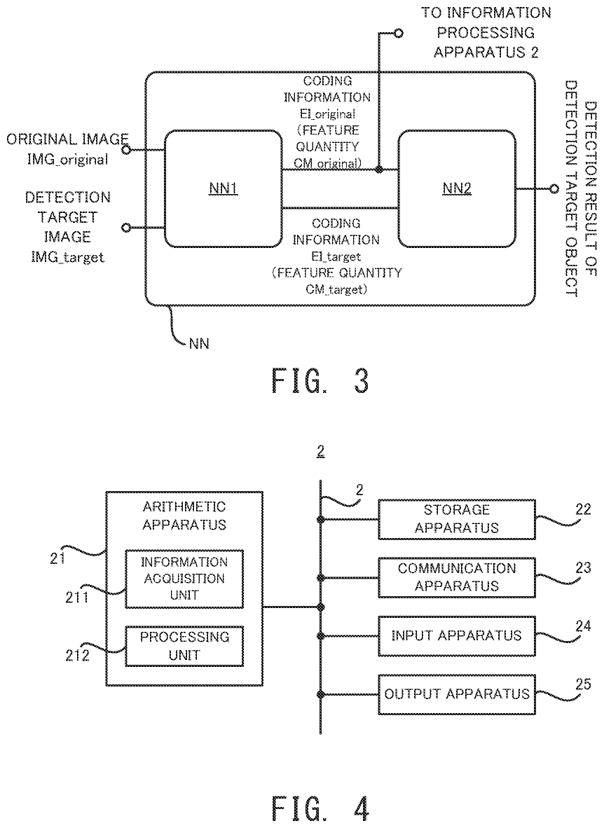

An example of the computational model generated by the machine learning is a neural network NN. FIG. 3 schematically illustrates an example of the neural network NN used by the encoding unit 111 and the object detection unit 112. As illustrated in FIG. 3, the neural network NN includes a network part NN1 that is a specific example of the “first model part”, and a network part NN2 that is a specific example of the “second model part”.

The network part NN1 is used by the encoding unit 111, mainly to generate the encoding information EI_original and EI_target (i.e., the feature quantities CM_original and CM_target). That is, the network part NN1 is a neural network for realizing the compression encoding model described above. The network part NN1 is capable of outputting, when the input image is inputted thereto, the encoding information that is the compressed, encoded input image so as to be decoded later and that is usable as the feature quantity of the input image. Therefore, when the original image IMG_original is inputted to the network part NN1, the network part NN1 outputs the encoding information EI_original (i.e., the feature quantity CM_original). When the detection target image IMG_target is inputted to the network part NN1, the network part NN1 outputs the encoding information EI_target (i.e., the feature quantity CM_target).

The network part NN1 may include a neural network conforming to a desired compression encoding method. For example, an encoder part of an autoencoder may be used as the network part NN1. In this case, the information processing apparatus 2 may generate the decoded image IMG_dec from the encoding information EI_original, by using a decoder part of the autoencoder.

The network part NN2 is used by the object detection unit 112, mainly to detect the detection target object in the original image IMG_original. That is, the network part NN2 is a neural network for realizing the object detection model described above. The network part NN2 outputs, when the feature quantity of one image and the feature quantity of another image are inputted thereto, a detection result of an object indicated by the other image in the one image. To the network part NN2, the feature quantities CM_original and CM_target, which are outputs of the network part NN1, are inputted. In this case, the network part NN2 outputs the detection result of the detection target object indicated by the detection target image IMG_target, in the original image IMG_original. For example, the network part NN2 may output information about the presence or absence of the detection target object in the original image IMG_original, as the detection result of the detection target object. The network part NN2 may output information about a position of the detection target image IMG_target (e.g., a position of a bounding box) in the original image IMG_original, as the detection result of the detection target object.

The network part NN2 may include a neural network conforming to a desired object detection method for detecting an object by using two images. For example, an example of the neural network conforming to the desired object detection method for detecting an object by using two images is SiamRPN (Siamese Region Proposal Network).

Referring back to FIG. 2, the transmission control unit 113 transmits the encoding information EI_original generated by the encoding unit 111, to the information processing apparatus 2, by using the communication apparatus 13. More specifically, as illustrated in FIG. 3, the transmission control unit 113 transmits the encoding information EI_original outputted by the network part NN1, to the information processing apparatus 2, by using the communication apparatus 13. Furthermore, the transmission control unit 113 may transmit the encoding information EI_target generated by the encoding unit 111, to the information processing apparatus 2, by using the communication apparatus 13. More specifically, as illustrated in FIG. 3, the transmission control unit 113 may transmit the encoding information EI_target outputted by the network part NN1, to the information processing apparatus 2, by using the communication apparatus 13.

The storage apparatus 12 is configured to store desired data. For example, the storage apparatus 12 may temporarily store a computer program to be executed by the arithmetic apparatus 11. The storage apparatus 12 may temporarily store data that are temporarily used by the arithmetic apparatus 11 when the arithmetic apparatus 11 executes the computer program. The storage apparatus 12 may store data that are stored by the object detection apparatus 1 for a long time. The storage apparatus 12 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 12 may include a non-transitory recording medium.

The communication apparatus 13 is configured to communicate with the information processing apparatus 2 through the communication line 3. In the example embodiment, the communication apparatus 13 transmits the encoding information EI_original to the information processing apparatus 2 through the communication line 3, under the control of the transmission control unit 113. Furthermore, the communication apparatus 13 may transmit the encoding information EI_target to the information processing apparatus 2 through the communication line 3, under the control of the transmission control unit 113.

The input apparatus 14 is an apparatus that receives an input of information to the object detection apparatus 1 from the outside of the object detection apparatus 1. For example, the input apparatus 14 may include an operating apparatus (e.g., at least one of a keyboard, a mouse, and a touch panel) that is operable by an operator of the object detection apparatus 1. For example, the input apparatus 14 may include a reading apparatus that is configured to read information recorded as data on a recording medium that can be externally attached to the object detection apparatus 1.

The output apparatus 15 is an apparatus that outputs information to the outside of the object detection apparatus 1. For example, the output apparatus 15 may output the information as an image. That is, the output apparatus 15 may include a display apparatus (a so-called display) that is configured to display an image indicating the information that is desirably outputted. For example, the output apparatus 15 may output information as audio. That is, the output apparatus 15 may include an audio apparatus (a so-called speaker) that is configured to output the audio. For example, the output apparatus 15 may output information onto a paper surface. That is, the output apparatus 15 may include a print apparatus (a so-called printer) that is configured to print desired information on the paper surface.

### <1-3> Configuration of Information Processing Apparatus 2

Next, a configuration of the information processing apparatus 2 will be described with reference to FIG. 4. FIG. 4 is a block diagram illustrating the configuration of the information processing apparatus 2;

As illustrated in FIG. 4, the information processing apparatus 2 includes an arithmetic apparatus 21, a storage apparatus 22, and a communication apparatus 23. Furthermore, the information processing apparatus 2 may include an input apparatus 24 and an output apparatus 25. The information processing apparatus 2, however, may not include at least one of the input apparatus 24 and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes, for example, at least one of a CPU, a GPU, and a FPGA. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2. The arithmetic apparatus 21 may obtain (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical function block for performing an operation to be performed by the information processing apparatus 2 is realized or implemented in the arithmetic apparatus 21. That is, the arithmetic apparatus 21 is allowed to function as a controller for realizing or implementing the logical functional block for performing the operation to be performed by the information processing apparatus 2.

FIG. 4 illustrates an example of the logical functional block realized or implemented in the arithmetic apparatus 21. As illustrated in FIG. 4, an information acquisition unit 211 and a processing unit 212 are realized or implemented in the arithmetic apparatus 21. The information acquisition unit 211 receives (i.e., obtains) the encoding information EI_original transmitted from the object detection apparatus 1, by using the communication apparatus 23. The processing unit 212 performs a predetermined operation using the encoding information EI_original. In this example embodiment, the processing unit 212 performs a decoding operation of decoding the encoding information EI_original obtained by the information acquisition unit 211, thereby to generate the decoded image IMG_dec. Furthermore, the processing unit 212 may perform an image analysis operation of analyzing the decoded image IMG_dec.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM, a ROM, a hard disk apparatus, a magneto-optical disk apparatus, a SSD, and a disk array apparatus. That is, the storage apparatus 22 may include a non-transitory recording medium.

The communication apparatus 23 is configured to communicate with the object detection apparatus 1 through the communication line 3. In the example embodiment, the communication apparatus 23 may receive (i.e., obtain) the encoding information EI_original from the object detection apparatus 1 through the communication line 3, under the control of the information acquisition unit 211.

The input apparatus 24 is an apparatus that receives an input of information to the information processing apparatus 2 from the outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that can be externally attached to the information processing apparatus 2.

The output apparatus 25 is an apparatus that outputs information to the outside of the information processing apparatus 2. For example, the output apparatus 25 may output the information as an image. That is, the output apparatus 25 may include a display apparatus (a so-called display) that is configured to display an image indicating the information that is desirably outputted. For example, the output apparatus 25 may output information as audio. That is, the output apparatus 25 may include an audio apparatus (a so-called speaker) that is configured to output the audio. For example, the output apparatus 25 may output information onto a paper surface. That is, the output apparatus 25 may include a print apparatus (a so-called printer) that is configured to print desired information on the paper surface.

### <2> Operation of Object Detection System SYS

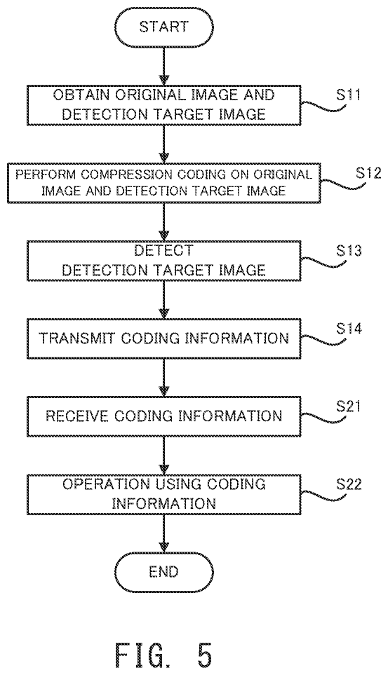

Next, with reference to FIG. 5, operation performed by the object detection system SYS will be described. FIG. 5 is a flowchart illustrating a flow of the operation performed by the object detection system SYS.

As illustrated in FIG. 5, the object detection apparatus 1 (especially, the encoding unit 111) obtains the original image IMG_original (step S11). For example, the object detection apparatus 1 may obtain the original image IMG_original from a camera that is a specific example of the image generation apparatus. In this instance, the object detection apparatus 1 may obtain the original image IMG_original from the camera at each time when the camera generates the original image IMG_original. The object detection apparatus 1 may obtain a plurality of original images IMG_original as time series data, from the camera. In this situation, the operation illustrated in FIG. 5 is performed by using each of the original images IMG_original.

In addition, the object detection apparatus 1 (especially, the encoding unit 111) obtains the detection target image IMG_target (step S11). For example, when the detection target image IMG_target is stored in the storage apparatus 12, the object detection apparatus 1 may obtain the detection target image IMG_target from the storage apparatus 12. For example, when the detection target image IMG_target is recorded on the recording medium that can be externally attached to the object detection apparatus 1, the object detection apparatus 1 may obtain the detection target image IMG_target from the recording medium, by using the recording medium reading apparatus provided in the object detection apparatus 1 (e.g., the input apparatus 14). For example, when the detection target image IMG_target is recorded in an external apparatus (e.g. a server) of the object detection apparatus 1, the object detection apparatus 1 may obtain the detection target image IMG_target from the external apparatus, by using the communication apparatus 13.

When the detection target object does not change, the object detection apparatus 1 may not need to obtain the detection target image IMG_target again after obtaining the detection target image IMG_target. In other words, the object detection apparatus 1 may obtain the detection target image IMG_target when the detection target object changes.

Thereafter, the object detection apparatus 1 (especially, the encoding unit 111) performs the compression encoding on the original image IMG_original so as to be decoded later, thereby to generate the encoding information EI_original that is usable as the feature quantity CM_original of the original image IMG_original (step S12). Furthermore, the object detection apparatus 1 (especially, the encoding unit 111) performs the compression encoding on the detection target image IMG_target so as to be decoded later, thereby to generate the encoding information EI_target that is usable as the feature quantity CM_target of the detection target image IMG_target (step S12).

Thereafter, the object detection apparatus 1 (especially, the object detection unit 112) detects the detection target object in the original image IMG_original, on the basis of the feature quantities CM_original and CM_target generated in the step S12 (step S13). The operation of detecting the detection target object may include an operation of detecting an area of a desired shape including the detection target object in the original image IMG_original (e.g., a rectangular area, and a so-called bounding box). The operation of detecting the detection target object may include an operation of detecting a position (e.g., a coordinate value) of the area of the desired shape including the detection target object in the original image IMG_original. The operation of detecting the detection target object may include an operation of detecting a property (e.g., at least one of color, shape, size, and direction) of the detection target object in the original image IMG_original.

The detection result of the detection target object in the step S13 may be used in a desired application. For example, as described above, the detection result of the detection target object in the step S13 may be used in the AR application. That is, the detection result of the detection target object in the step S13 may be used in the application of placing a virtual object at the position of the detection target object.

In parallel with, or before or after the step S13, the object detection apparatus 1 (especially, the transmission control unit 113) transmits the encoding information EI_original generated in the step S12, to the information processing apparatus 2, by using the communication apparatus 13 (step S14). Here, a data size of the encoding information EI_original is smaller than that of the original image IMG_original, because the encoding information EI_original is the compressed, encoded original image IMG_original. Therefore, as compared with the cases where the original image IMG_original is transmitted to the information processing apparatus 2 through the communication line 3, it is more likely to satisfy the bandwidth constraints on the communication line 3. That is, even when the bandwidth of the communication line 3 is relatively narrow (i.e., an amount of data that can be transmitted per unit time is relatively small), the object detection apparatus 1 is capable of transmitting the encoding information EI_original to the information processing apparatus 2.

Consequently, the information processing apparatus 2 (especially, the information acquisition unit 211) receives the encoding information EI_original transmitted from the object detection apparatus 1, by using the communication apparatus 23 (step S21). Thereafter, the information processing apparatus 2 (especially, the processing unit 212) performs the predetermined operation using the encoding information EI_original (step S22). For example, the processing unit 212 may perform the decoding operation of decoding the encoding information EI_original obtained by the information acquisition unit 211, thereby to generate the decoded image IMG_dec. The processing unit 212 may perform the image analysis operation of analyzing the decoded image IMG_dec.

### <3> Generation of Computational Model by Machine Learning

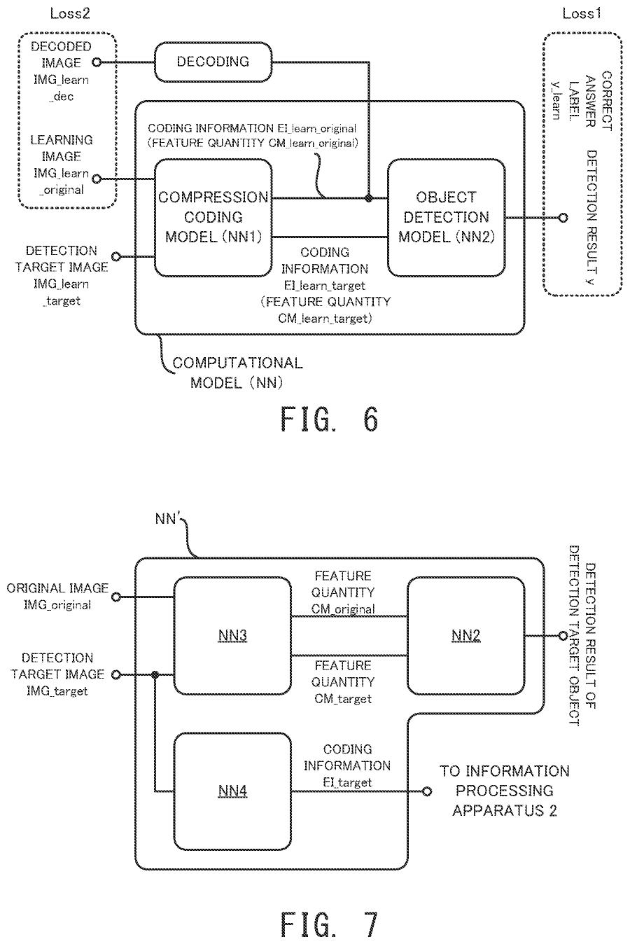

Next, with reference to FIG. 6, the machine learning for generating the computational model used by the object detection apparatus 1 will be described. FIG. 6 conceptually illustrates the machine learning for generating the computational modeling used by the object detection apparatus 1. The following describes, for convenience of description, the machine learning to be performed when the computational model is the neural network NN in FIG. 3. However, even when the computational model is different from the neural network NN in FIG. 3, the computational model may be generated by the machine learning described below.

The neural network NN is generated by the machine learning using a learning data set including a plurality of learning data in which an image for learning (hereafter referred to as a “learning image IMG_learn_original”) is associated with a ground truth label y_learn of the detection result of the detection target object in the learning image IMG_learn_original. Furthermore, even after the neural network NN is once generated, the neural network NN may be updated as appropriate by the machine learning using a learning data set including new learning data.

To generate or update the neural network NN, the learning image IMG_learn_original included in the learning data is inputted to the network part NN1 (i.e., the compression encoding model) included in the initial or generated neural network NN. Consequently, the network part NN1 performs the compression encoding on the learning image IMG_learn_original so as to be decoded later, thereby to output encoding information EI_learn that is the compressed, encoded learning image IMG_learn_original and that is usable as a feature quantity CM_learn_original of the learning image IMG_learn_original. In addition, a detection target image for learning (hereafter referred to as a “detection target image IMG_learn_target”) indicating a detection target object for learning is inputted to the network part NN1 included in the initial or generated neural network NN. Consequently, the network part NN1 performs the compression encoding on the detection target image IMG_learn_target so as to be decoded later, thereby to output encoding information EI_learn_target that is the compressed, encoded detection target image IMG_learn_target and that is usable as a feature quantity CM_learn_target of the detection target image IMG_learn_target.

Subsequently, the output of the network part NN1 (i.e., the feature quantitues CM_learn_original and CM_learn_target) is inputted to the network part NN2 (i.e., the object detection model) included in the initial or generated neural network NN. As a result, the network part NN2 outputs an actual detection result y of the detection target object in the learning image IMG_learn_original. In addition, the encoding information EI_learn_original outputted by the network part NN2 is decoded. Consequently, a decoded image IMG_learn_dec is generated.

The above operation is repeatedly performed on the plurality of learning data (or a part thereof) included in the learning data set. Furthermore, the operation performed on the plurality of learning data (or a part thereof) may be repeatedly performed on a plurality of detection target images IMG_learn_target.

The neural network NN is then generated or updated, by using a loss function Loss including a loss function Loss1 for the detection of the detection target object and a loss function Loss2 for the compression encoding and the decoding. The loss function Loss1 is a loss function for an error between the output y of the network part NN2 (i.e., the actual detection result of the detection target object in the learning image IMG_learn_original, by the network part NN2) and the ground truth label y_learn. For example, the loss function Loss1 may be a loss function that is reduced as the error between the output y of the network part NN2 and the correct label y_learn is reduced. On the other hand, the loss function Loss2 is a loss function for an error between the decoded image IMG_learn_dec and the learning image IMG_learn_original. For example, the loss function Loss2 may be a loss function that is reduced as the error between the decoded image IMG_learn_dec and the learned image IMG_learn_original is reduced.

The neural network NN may be generated or updated to minimize the loss function Loss. In this instance, the neural network NN may be generated or updated to minimize the loss function Loss, by using existing algorithms for performing the machine learning. For example, the neural network NN may be generated or updated to minimize the loss function Loss, by using error back propagation. Consequently, the neural network NN is generated or updated.

### <4> Technical Effect of Object Detection System SYS

As described above, in the example embodiment, the object detection apparatus 1 performs the compression encoding on the original image IMG_original, thereby to generate the encoding information EI_original that is usable as the feature quantity CM_original of the original image IMG_original. That is, the object detection apparatus 1 may not need to independently perform an operation of generating the feature quantity CM_original and an operation of generating the encoding information EI_original. The object detection apparatus 1 may not need to perform the operation of generating the feature quantity CM_original independently of the encoding information EI_original. The object detection apparatus 1 may not need to perform the operation of generating the encoding information EI_original independently of the feature quantity CM_original. This allows a reduction in a processing load for compressing the original image IMG_original and for detecting the detection target object in the original image IMG_original.

Specifically, as illustrated in FIG. 7, an object detection apparatus in a comparative example that does not generate the encoding information EI_original that is usable as the feature quantity CM_original needs to independently perform the operation of generating the feature quantity CM_original and the operation of generating the encoding information EI_original. In the example illustrated in FIG. 7, the object detection apparatus in the comparative example compresses the original image IMG_original and detects the detection target object in the original image IMG_original, by using a neural network NN including a network part NN3 for generating the feature quantity CM_original independently of the encoding information EI_original, a network part NN4 for generating the encoding information EI_original independently of the feature quantity CM_original, and the network part NN2 for detecting the detection target object on the basis of the feature quantity CM_original. In contrast to the object detection apparatus in the comparative example, the object detection apparatus 1 according to the example embodiment may not include any one of the network parts NN3 and NN4. Therefore, the structure of the neural network NN used by the object detection apparatus 1 is simplified more than that of the neural network NN used by the object detection apparatus in the comparative example. That is, the structure of the computational model used by the object detection apparatus 1 is simplified more than that of a computational model used by the object detection apparatus in the comparative example. Consequently, in the example embodiment, as compared with the comparative example, it is possible to reduce the processing load for compressing the original image IMG_original and for generating the feature quantity CM_original of the original image IMG_original. That is, in the example embodiment, as compared with the comparative example, it is possible to reduce the processing load for compressing the original image IMG_original and for detecting the detection target object in the original image IMG_original.

Furthermore, the neural network NN (i.e., the computational model) is generated, by the machine learning using the loss function Loss including the loss function Loss1 for the detection of the detection target object and the loss function Loss2 for the compression encoding and the decoding. Therefore, generated is the computational model that is capable of properly generating the encoding information EI_original that is the compressed original image IMG_original and that is usable as the feature quantity CM_original of the original image IMG_original. Consequently, the object detection apparatus 1 is allowed to perform the compression encoding on the original image IMG_original by using the computational model generated in this manner, thereby to properly generate the encoding information EI_original that is the compressed original image IMG_original and that is usable as the feature quantity CM_original of the original image IMG_original.

### <5> Modified Example

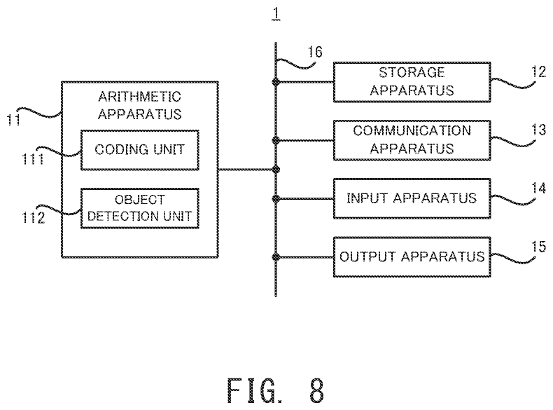

In the above description, the object detection apparatus 1 transmits the encoding information EI_original to the information processing apparatus 2. The object detection apparatus 1, however, may not need to transmit the encoding information EI_original to the information processing apparatus 2. For example, the object detection apparatus 1 may store the encoding information EI_original in the storage apparatus 12. In this instance, as illustrated in FIG. 8, the object detection apparatus 1 may not include the transmission control unit 113.

In the above description, the object detection apparatus 1 uses the original image IMG_original and the detection target image IMG_target to detect, in the original image IMG_original, the detection target object indicated by the detection target image IMG_target. The object detection apparatus 1, however, may detect the detection target object in the original image IMG_original without using the detection target image IMG_target. For example, the object detection apparatus 1 may detect a target object, by using a computational model conforming to a desired object detection method for detecting an object by using an image in which the object is to be detected. An example of the computational model conforming to the desired object detection method for detecting an object by using an image in which the object is to be detected, is a computational model conforming to YOLO (You Only Look Once). Even in this case, the object detection apparatus 1 may perform the compression encoding on the original image IMG_original so as to be decoded later, thereby to generate the encoding information EI_original that is the compressed, encoded original image IMG_original and that is usable as the feature quantity CM_original of the original image IMG_original. Consequently, the object detection apparatus 1 is allowed to enjoy the benefits described above.

As an example, when the computational model conforming to YOLO described above is used, machine learning of the computational model conforming to YOLO may be performed such that outputs of intermediate layers of the computational model conforming to YOLO can be decoded. That is, the machine learning may be performed to generate a computational model obtained by extending YOLO while complying to YOLO so as to include the intermediate layers in which the outputs thereof can be decoded later. As a consequence, the intermediate layers of the computational model conforming to YOLO are usable as the feature quantities for the object detection and are allowed to output the encoding information that can be decoded later. Therefore, even the object detection apparatus 1 that performs the object detection by using the computational model conforming to YOLO, is allowed to enjoy the benefits described above.

In the above description, the information processing apparatus 2 performs the decoding operation of decoding the encoding information EI_original, thereby to generate the decoded image IMG_dec and the image analysis operation of analyzing the decoded image IMG_dec, as an example of the predetermined operation. The information processing apparatus 2, however, may perform an operation that is different from the decoding operation and the image analysis operation. For example, the information processing apparatus 2 may perform an operation of storing the encoding information EI_original received from the object detection apparatus 1, in the storage apparatus 22. For example, the information processing apparatus 2 may perform an operation of storing the decoded image IMG_dec generated from the encoding information EI_original, in the storage apparatus 22.

### <6> Supplementary Notes

With respect to the example embodiment described above, the following Supplementary Notes are further disclosed.

### [Supplementary Note 1]

An object detection apparatus including:
a generation unit that performs compression encoding on each of a first image obtained from an image generation apparatus and a second image indicating a detection target object so as to extract a feature quantity that allows object detection and so as to be decoded later, thereby generate respective one of first encoding information that is the compressed, encoded first image and that is usable as a first feature quantity that is the feature quantity of the first image, and second encoding information that is the compressed, encoded second image and that is usable as a second feature quantity that is the feature quantity of the second image; and
a detection unit that detects the detection target object in the first image, by using the first and second feature quantities.

### [Supplementary Note 2]

The object detection apparatus according to Supplementary Note 1, further including a transmission unit that transmits the first encoding information to an information processing apparatus that performs a predetermined operation using the first encoding information, through a communication line.

### [Supplementary Note 3]

The object detection apparatus according to Supplementary Note 2, wherein the predetermined operation includes at least one of: a first operation of decoding the first encoding information, thereby to generate a third image; a second operation of analyzing the third image; a third operation of storing the first encoding information in a storage apparatus; and a fourth operation of storing the third image in a storage apparatus.

### [Supplementary Note 4]

The object detection apparatus according to any one of Supplementary Notes 1 to 3, wherein
the generation unit generates the first and second encoding information that are respectively usable as the first and second feature quantities, by using a first model part that outputs the first and second encoding information when the first and second images are inputted, of a computational model generated by machine learning,
the detection unit detects the detection target object, by using a second model part that outputs a detection result of the detection target object in the first image when the first and second feature quantities are inputted, of the computational model, and
the computational model is generated by machine learning using a first loss function and a second loss function, the first loss function being based on an error between the detection result of the detection target object outputted by the second model part of the computational model to which a fourth image for learning is inputted and a ground truth label of the detection result of the detection target object in the fourth image, the second loss function being based on an error between a third image generated by decoding the first encoding information outputted by the first model part of the computational model to which the fourth image is inputted and the fourth image.

### [Supplementary Note 5]

The object detection apparatus according to Supplementary Note 4, wherein
the computational model includes a neural network, and
the first model part includes an encoder part of an autoencoder.

### [Supplementary Note 6]

An object detection system comprising an object detection apparatus and an information processing apparatus,
the object detection apparatus including:
a generation unit that performs compression encoding on each of a first image obtained from an image generation apparatus and a second image indicating a detection target object so as to extract a feature quantity that allows object detection and so as to be decoded later, thereby generate respective one of first encoding information that is the compressed, encoded first image and that is usable as a first feature quantity that is the feature quantity of the first image, and second encoding information that is the compressed, encoded second image and that is usable as a second feature quantity that is the feature quantity of the second image;
a detection unit that detects the detection target object in the first image, by using the first and second feature quantities; and
a transmission unit that transmits the first encoding information to the information processing apparatus, through a communication line,
the information processing apparatus performing a predetermined operation using the first encoding information.

### [Supplementary Note 7]

An object detection method including:
performing compression encoding on each of a first image obtained from an image generation apparatus and a second image indicating a detection target object so as to extract a feature quantity that allows object detection and so as to be decoded later, thereby generate respective one of first encoding information that is the compressed, encoded first image and that is usable as a first feature quantity that is the feature quantity of the first image, and second encoding information that is the compressed, encoded second image and that is usable as a second feature quantity that is the feature quantity of the second image; and
detecting the detection target object in the first image, by using the first and second feature quantities.

### [Supplementary Note 8]

A recording medium on which a computer program that allows a computer to execute an object detection method is recorded, the object detection method including:
performing compression encoding on each of a first image obtained from an image generation apparatus and a second image indicating a detection target object so as to extract a feature quantity that allows object detection and so as to be decoded later, thereby generate respective one of first encoding information that is the compressed, encoded first image and that is usable as a first feature quantity that is the feature quantity of the first image, and second encoding information that is the compressed, encoded second image and that is usable as a second feature quantity that is the feature quantity of the second image; and
detecting the detection target object in the first image, by using the first and second feature quantities.

At least a part of the constituent components of the above-described example embodiment can be combined with at least another part of the constituent components of the above-described example embodiment, as appropriate. A part of the constituent components of the above-described example embodiment may not be used. Furthermore, to the extent permitted by law, all the references (e.g., publications) cited in this disclosure are incorporate by reference as a part of the description of this disclosure.

This disclosure is not limited to the examples described above and is allowed to be changed, if desired, without departing from the essence or spirit of this disclosure which can be read from the claims and the entire identification. An object detection apparatus, an object detection system, an object detection method, and a recording medium with such modifications, are also intended to be within the technical scope of this disclosure.

### DESCRIPTION OF REFERENCE CODES

SYS Object detection system
1 Object Detection apparatus
11 Arithmetic apparatus
111 Encoding unit
112 Object detection unit
113 Transmission control unit
2 Information processing apparatus
IMG_original Original image
IMG_target Detection target image
EI_original and EI_target Encoding information
CM_original and CM_target Feature quantity
NN Neural network
NN1, NN2 Network part

What is claimed is:

1. An object detection apparatus comprising:
at least one memory configured to store instructions; and
at least one processor configured to execute the instructions to:
perform compression encoding on each of a first image obtained from an image generation apparatus and a second image indicating a detection target object so as to extract a feature quantity that allows object detection and so as to be decoded later, thereby generate respective one of first encoding information that is usable as a first feature quantity of the first image and that is compressed, and second encoding information that is usable as a second feature quantity of the second image and that is compressed; and
detect the detection target object in the first image, by using the first and second feature quantities.

2. The object detection apparatus according to claim 1, wherein
the at least one processor is configured to execute the instructions to transmit the first encoding information to an information processing apparatus that performs a predetermined operation using the first encoding information, through a communication line.

3. The object detection apparatus according to claim 2, wherein the predetermined operation includes at least one of: a first operation of decoding the first encoding information, thereby to generate a third image; a second operation of analyzing the third image; a third operation of storing the first encoding information in a storage apparatus; and a fourth operation of storing the third image in a storage apparatus.

4. The object detection apparatus according to claim 1 wherein
the at least one processor is configured to execute the instructions to:
generate the first and second encoding information that are respectively usable as the first and second feature quantities, by using a first model part that outputs the first and second encoding information when the first and second images are inputted, of a computational model generated by machine learning; and
detect the detection target object, by using a second model part that outputs a detection result of the detection target object in the first image when the first and second feature quantities are inputted, of the computational model,
the computational model is generated by machine learning using a first loss function and a second loss function, the first loss function being based on an error between the detection result of the detection target object outputted by the second model part of the computational model to which a fourth image for learning is inputted and a ground truth label of the detection result of the detection target object in the fourth image, the second loss function being based on an error between a third image generated by decoding the first encoding information outputted by the first model part of the computational model to which the fourth image is inputted and the fourth image.

5. The object detection apparatus according to claim 4, wherein
the computational model includes a neural network, and
the first model part includes an encoder part of an autoencoder.

6. An object detection system comprising an object detection apparatus and an information processing apparatus,
the object detection apparatus including:
at least one first memory configured to store instructions; and
at least one first processor configured to execute the instructions to:
perform compression coding on each of a first image obtained from an image generation apparatus and a second image indicating a detection target object so as to extract a feature quantity that allows object detection and so as to be decoded later, thereby generate respective one of first encoding information that is usable as a first feature quantity of the first image and that is compressed, and second encoding information that is usable as a second feature quantity of the second image and that is compressed;
detect the detection target object in the first image, by using the first and second feature quantities; and
transmit the first encoding information to the information processing apparatus, through a communication line,
the information processing apparatus including:
at least one second memory configured to store instructions; and
at least one second processor configured to execute the instructions to perform a predetermined operation using the first encoding information.

7. An object detection method comprising:
performing compression coding on each of a first image obtained from an image generation apparatus and a second image indicating a detection target object so as to extract a feature quantity that allows object detection and so as to be decoded later, thereby generate respective one of first encoding information that is usable as a first feature quantity of the first image and that is compressed, and second encoding information that is usable as a second feature quantity of the second image and that is compressed; and
detecting the detection target object in the first image, by using the first and second feature quantities.

8. (canceled)
